(19) United States
(12) Patent Application Publication
(10) Pub. No.: US 2026/0134658 A1
(43) Pub. Date: May 14, 2026

(54) GENERATING ENHANCED VIDEO STREAM BASED ON DATA RECEIVED FROM AN UNMANNED VEHICLE

(71) Applicant: SRI International, Menlo Park, CA (US)

(72) Inventors: Ion Matei, Mountain View, CA (US); Wiktor M. Piotrowski, Redwood City, CA (US); Johan de Kleer, Los Altos, CA (US)

(21) Appl. No.: 18/988,464

(22) Filed: Dec. 19, 2024

Related U.S. Application Data
(60) Provisional application No. 63/619,219, filed on Jan. 9, 2024.

(51) Int. Cl. H04N 7/18; G06T 11/00; G06V 10/70; G06V 20/40; G06V 20/58

(52) U.S. Cl. CPC G06V 10/70; G06T 11/00; G06V 20/40; G06V 20/58

(57) ABSTRACT

An example computing system includes processing circuitry; and memory configured to store a machine learning model, wherein the processing circuitry is configured to: receive unmanned vehicle information from an unmanned vehicle, the unmanned vehicle information including video data comprising a plurality of video frames; determine to add one or more additional video frames to the plurality of the video frames; process, with the machine learning model, the unmanned vehicle information and environment information for the unmanned vehicle to generate the one or more additional video frames; and output a video stream comprising the video frames and the one or more additional video frames.

This application claims the benefit of U.S. patent application Ser. No. 63/619,219, filed Jan. 9, 2024, which is incorporated by reference herein in its entirety.

### TECHNICAL FIELD

This disclosure is related to computing systems, and more specifically to computing systems communicating with unmanned vehicles.

### BACKGROUND

Unmanned vehicles, such as first-person view (FPV) drones, have emerged as highly effective instruments for various actions, such as engaging a target remotely. These unmanned vehicles may have low observability due to being smaller in size but may have unreliable communication with their operator due to limited operational ranges of the communication system of the unmanned vehicle or jamming.

### SUMMARY

Unmanned vehicles may be controlled by an operator remotely via a computing system. The operator may provide the unmanned vehicle with information about an item of interest that may help guide the unmanned vehicle to a particular location to identify and/or engage the item of interest. Once an item of interest is identified, an operator may be faced with challenging tasks of making engagement decisions while taking into account various factors, such as classification of the item of interest, mobility status of the item of interest (e.g., whether the item of interest is in motion or stationary), known vulnerabilities, remaining power of the unmanned vehicle, etc. Operators may craft plans that are contingent upon situational awareness, which may be determined based on a continuous stream of unmanned vehicle information. The unmanned vehicle information may include multi-modal sensor data that may include, e.g., one or more of video data, audio data, infrared data, ranging data, accelerometer data, global positioning system (GPS) data, altimeter data, or compass data, such as gyrocompass data. The unmanned vehicle may transmit unmanned vehicle information to a computing system via communication signals. However, the quality of the communication signals carrying the unmanned vehicle information may fluctuate for various reasons, such as geography of the operation area of the unmanned vehicle, range, communication limitations, and/or deliberate communication jamming.

Unmanned vehicle may communicate with a computing system via radio communication signals. Longer ranges of communication may be achieved via lower communication frequencies. However, lower communication frequencies may lead to a reduced amount of unmanned vehicle information, such as a reduced number of video frames received from the unmanned vehicle, which may lead to reduced operator situational awareness. An unmanned vehicle communicating via lower communication frequencies may also lead to the unmanned vehicle receiving controls signals from the computing system at a slower rate, which may make the unmanned vehicle less responsive to an operator's commands.

In general, the disclosure describes a computing system that can receive unmanned vehicle information from an unmanned vehicle, the unmanned vehicle information including video data that includes a plurality of video frames. The computing system can generate, with a machine learning (ML) model, one or more additional video frames based on processing the unmanned vehicle information and environment information. The computing system may output a video stream, such as for viewing by an operator of the unmanned vehicle, comprising video frames received from the unmanned vehicle and the one or more additional video frames generated by the ML model. Generating and including the one or more additional video frames in the video stream may inform an operator of a predicted situation in which the unmanned vehicle may be operating when the computing system does not receive consistent video data from the unmanned vehicle. In some examples, the computing system may generate one or more additional video frames to be interspersed between video frames that are received to provide an improved video stream to generate a higher-quality video stream than what is provided in the video data received from the unmanned vehicle.

In some examples, the generated additional video frames may represent a plurality of seconds of additional video data to help provide the operator with a projected view of the unmanned vehicle's environment, which can include an item of interest, even when the computing system is not receiving video data or is receiving lower frame-rate video data from the unmanned vehicle for a period of time. In some examples, the generated additional video frames may comprise frames to be interspersed between received frames to generate a higher-quality video stream than the video data received from the unmanned vehicle provide the operator with a more detailed view of the unmanned vehicle's environment or and/or the item of interest.

The computing systems and/or methods of this disclosure may provide one or more technical advantages. For example, the computing systems and/or methods may extend an unmanned vehicle's operational range, mitigate the effects of lower communication rates, and/or increase the amount of information provided to an operator of an unmanned vehicle. These technical advantages may bolster an operator's decision-making capabilities and overall operations of the unmanned vehicle.

In an example, a computing system to generate one or more additional video frames to add to video data received from an unmanned vehicle to generate a video stream comprises processing circuitry; and memory configured to store a machine learning model, wherein the processing circuitry is configured to: receive unmanned vehicle information from the unmanned vehicle, the unmanned vehicle information including the video data comprising a plurality of video frames; determine to add the one or more additional video frames to the plurality of the video frames; process, with the machine learning model, the unmanned vehicle information and environment information for the unmanned vehicle to generate the one or more additional video frames, the environment information being based on the unmanned vehicle information and including at least one of item of interest information, terrain information, location information for the unmanned vehicle, a trajectory of the unmanned vehicle, or a planned trajectory of the unmanned vehicle; and output the video stream comprising the video frames and the one or more additional video frames.

In an example, a method for generating one or more additional video frames to add to video data received from an unmanned vehicle to generate a video stream, the method includes receiving unmanned vehicle information from the unmanned vehicle, the unmanned vehicle information including the video data comprising a plurality of video frames; determining to the add one or more additional video data frames to the plurality of the video frames; processing, with a machine learning model, the unmanned vehicle information and environment information for the unmanned vehicle to generate the one or more additional video frames, the environment information being based on the unmanned vehicle information and including at least one of item of interest information, terrain information, location information for the unmanned vehicle, a trajectory of the unmanned vehicle, or a planned trajectory of the unmanned vehicle; and outputting the video stream comprising the video frames and the one or more additional video frames.

In an example, a non-transitory computer-readable medium comprises machine readable instructions for causing processing circuitry to perform operations comprising: receive unmanned vehicle information from an unmanned vehicle, the unmanned vehicle information including video data comprising a plurality of video frames; determine to add one or more additional video data frames to the plurality of the video frames; process, with a machine learning model, the unmanned vehicle information and environment information for the unmanned vehicle to generate the one or more additional video frames, the environment information being based on the unmanned vehicle information and including at least one of item of interest information, terrain information, location information for the unmanned vehicle, a trajectory of the unmanned vehicle, or a planned trajectory of the unmanned vehicle; and output a video stream comprising the video frames and the one or more additional video frames.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating example system in accordance with the techniques of the disclosure.

FIGS. 2A-2B are diagrams illustrating example techniques of combining generated additional video frames with video frames received from an unmanned vehicle.

FIG. 3 is a flowchart illustrating an example mode of operation for a computing system, according to techniques described in this disclosure.

Like reference characters refer to like elements throughout the figures and description.

### DETAILED DESCRIPTION

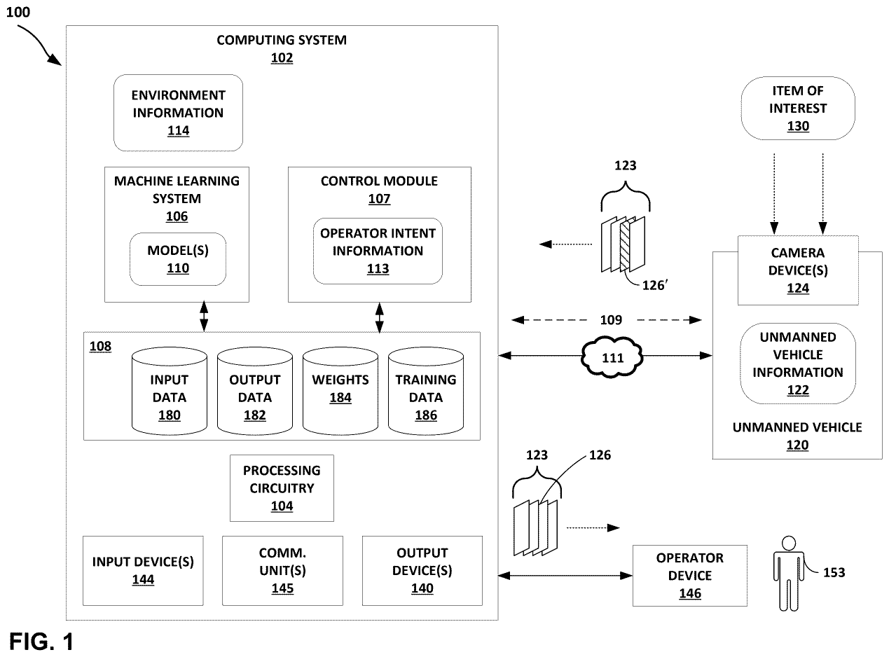

FIG. 1 is a block diagram illustrating example system 100 in accordance with the techniques of the disclosure. As shown, computing system 102 comprises processing circuitry 104 and memory 108 for executing a machine learning (ML) system 106 having one or more ML models 110 (illustrated as “model(s) 110”), which may be implemented as software, but may in some examples include any combination of hardware, firmware, and software. ML model(s) 110 may include one or more neural network models, each made up of a neural network having one or more parameterized layers. ML model(s) 110 may be any of various types of neural networks, such as, but not limited to, recursive neural networks (RNNs), convolutional neural networks (CNNs), deep neural networks (DNNs), or a combination thereof. An RNN may be based on a Long Short-Term Memory cell.

Computing system 102 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 102 may represent a cloud computing system, server farm, and/or server cluster (or portion thereof) that provides services to client devices and other devices or systems. In other examples, computing system 102 may represent or be implemented through one or more virtualized compute instances (e.g., virtual machines, containers) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 104 of computing system 102, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 104 of computing system 102 may implement functionality and/or execute instructions associated with computing system 102. Computing system 102 may use processing circuitry 104 to perform operations in accordance with one or more aspects of the present disclosure using software, hardware, firmware, or a mixture of hardware, software, and firmware residing in and/or executing at computing system 102. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 102 comprises any suitable computing system having one or more computing devices, such as unmanned vehicle controllers, desktop computers, laptop computers, gaming consoles, smart televisions, handheld devices, tablets, mobile telephones, smartphones, etc. In some examples, at least a portion of system 102 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 108 may comprise one or more storage devices. One or more components of computing system 102 (e.g., processing circuitry 104, memory 108, ML system 106, control module 107) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 108 may be distributed among multiple devices.

Memory 108 may store information for processing during operation of computing system 102. In some examples, memory 108 comprises temporary memories, meaning that a primary purpose of the one or more storage devices of memory 108 is not long-term storage. Memory 108 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 108, in some examples, may also include one or more computer-readable storage media. Memory 108 may be configured to store larger amounts of information than volatile memory. Memory 108 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 108 may store program instructions and/or data associated with one or more of the modules described in accordance with one or more aspects of this disclosure.

Processing circuitry 104 and memory 108 may provide an operating environment or platform for one or more modules or units (e.g., control module 107 and ML learning system 106) which may be implemented as software, but may in some examples include any combination of hardware, firmware, and software. Processing circuitry 104 may execute instructions and the one or more storage devices, e.g., memory 108, may store instructions and/or data of one or more modules. The combination of processing circuitry 104 and memory 108 may retrieve, store, and/or execute the instructions and/or data of one or more applications, modules, or software. The processing circuitry 104 and/or memory 108 may also be operably coupled to one or more other software and/or hardware components, including, but not limited to, one or more of the components illustrated in FIG. 1.

Processing circuitry 104 may execute one or more of machine learning system 106 or control module 107 using virtualization modules, such as a virtual machine or container executing on underlying hardware. One or more of such modules may execute as one or more services of an operating system or computing platform. Aspects of machine learning system 106 may execute as one or more executable programs at an application layer of a computing platform.

One or more input devices 144 of computing system 102 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 140 may generate, transmit, or process output. Examples of output are tactile, audio, visual, and/or video output. Output devices 140 may include a display, sound card, video graphics adapter card, speaker, presence-sensitive screen, one or more USB interfaces, video and/or audio output interfaces, or any other type of device capable of generating tactile, audio, video, or other output. Output devices 140 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 102 may include a presence-sensitive display that may serve as a user interface device that operates both as one or more input devices 144 and one or more output devices 140.

One or more communication units 145 of computing system 102 may communicate with devices external to computing system 102 (or among separate computing devices of computing system 102) by transmitting and/or receiving data, and may operate, in some respects, as both an input device and an output device. In some examples, communication units 145 may communicate with other devices over a network. In other examples, communication units 145 may send and/or receive radio signals on a radio network such as a cellular radio network or satellite network. Examples of communication units 145 may include a network interface card (e.g., such as an Ethernet card), an optical transceiver, a radio frequency transceiver, a GPS receiver, or any other type of device that can send and/or receive information. Other examples of communication units 145 may include Bluetooth®, GPS, 3G, 4G, and Wi-Fi® radios found in mobile devices as well as Universal Serial Bus (USB) controllers and the like.

In the example of FIG. 1, machine learning system 106 may receive input data 180 and may generate output data 182. Input data 180 and output data 182 may contain various types of information. For example, input data 180 may include at least one of unmanned vehicle information 122, operator intent information 113, or environment information 114. Output data 182 may include additional frames 126, projected environment information 114, a predicted trajectory of item of interest 130, or a predicted trajectory for unmanned vehicle 120, for example.

Machine learning system 106 may process training data 186 to train the ML model(s) 110. For example, machine learning system 106 may apply an end-to-end training method that includes processing training data 186. Machine learning system 106 may process input data 180 to generate relevant training examples that may be included in the training data 186.

In examples in which the ML model(s) 110 include layers, each of the layers may include a different set of artificial neurons. The layers can include an input layer, an output layer, and one or more hidden layers (which may also be referred to as intermediate layers). The layers may include fully connected layers, convolutional layers, pooling layers, and/or other types of layers. In a fully connected (or “dense”) layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer. Each input of each artificial neuron in each of the layers may be associated with a corresponding weight, and artificial neurons may each apply an activation function known in the art, such as Rectified Linear Unit (ReLU), TanH, Sigmoid, etc. In some examples, ML model(s) 110 may include one or more generative artificial intelligence (AI) models. In some examples, the generative AI models may include one or more Multi-Agent Controller (MAC) generators.

In some examples, computing system 102 may receive unmanned vehicle information 122 from an unmanned vehicle 120. In some examples, unmanned vehicle 120 may include at least one camera device 124 to record video data. In some examples, unmanned vehicle 120 may record audio data. In some examples, computing system 102 may receive unmanned vehicle information 122 from an unmanned vehicle 120 via communication signal(s) 109 that are transmitted/relayed from unmanned vehicle 120 to computing system 102 via network 111 or, in some cases, via a direct communication channel. Communication network 111 connecting the unmanned vehicle 120 with computing system 102 may be the internet or may include, be a part of, and/or represent any public or private communications network or other network. For instance, the network may each be a radio, cellular, satellite, enterprise, service provider, and/or other type of network enabling long-range communication transfer of data between computing systems, unmanned vehicles, servers, and computing devices. In some examples, communication network 111 may include one or more intermediary communication devices. Communication network 111 may include a communication link. The communication link may be a point-to-point communication link in which unmanned vehicle 120 and computing system 120 exchange communication signals 109 directly without relying on intermediate infrastructure (in which case communication network 111 is the communication link). The communication link may be a radio communication link operating at a frequency. One or more of unmanned vehicle 120, computing system 102, computing devices, server devices, or other devices may transmit and receive data, commands, control signals, and/or other information across the networks using any suitable communication techniques.

In some examples, unmanned vehicle 120 may comprise a vehicle, such as a robot, unmanned aerial vehicle (UAV), unmanned ground vehicle (UGV), unmanned surface vehicle (USV), unmanned underwater vehicle (UUV), unmanned space vehicle, drone, guided weapon, or other device or system that operates without a person on board the vehicle and that operates via one or more of autonomously or via instructions received via a computing system, such as computing system 102.

Computing system 102 may represent a command and control station (C2) for unmanned vehicle 120. Control module 107 executed by processing circuitry 104 receives operator intent information 113 from operator 153 via one or more input devices 144 or from operator device 146. In some examples, operator intent information 113 may include control instructions to be sent to unmanned vehicle 120, such as velocity, acceleration, trajectory, altitude, etc., of unmanned vehicle 120. Operator intent information 113 may additionally or alternatively include control instructions to be sent to unmanned vehicle 120 with respect to item of interest 130, such as a priority value of item of interest 130 or an identifier or description of item of interest 130. Control module 107 directs operation of unmanned vehicle 120 in accordance with operator intent information 113. Control module 107 may process, generate, and monitor communication signals 109.

While the following description is in reference to determining to add one or more additional video frames to video data recorded by unmanned vehicle 120 that comprises a plurality of video frames, the techniques described herein may similarly be applied to determine to add one or more additional audio frames to audio data record by unmanned vehicle 120 that comprises a plurality of audio frames. For example, when unmanned vehicle 120 is an UUV, unmanned vehicle 120 may record audio data comprising a plurality of the audio frames, such as via a sonar recording device, and computing system 102 may determine to add one or more additional audio frames to the plurality of the audio frames.

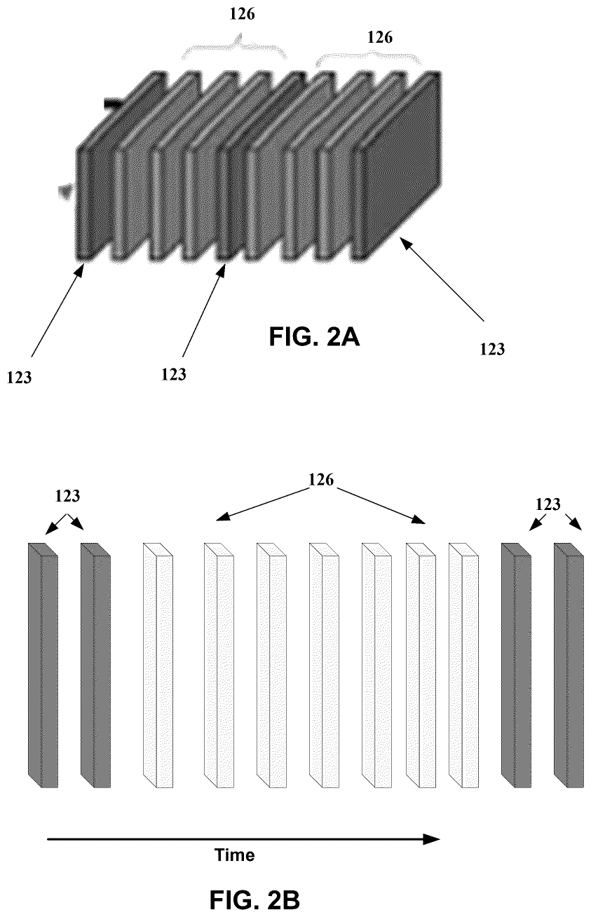

In some examples, instructions received via computing system 102 may include instructions input by a pilot of the unmanned vehicle. The unmanned vehicle information 122 may include video data captured by camera device(s) 124 and comprising a plurality of video frames 123, such as shown in FIGS. 2A-2B. In some examples, unmanned vehicle information may further 122 include at least one of accelerometer data of the unmanned vehicle 120 or global positioning system (GPS) data of the unmanned vehicle 120. In some examples, computing system 102 may receive unmanned vehicle information 122 via communication signal(s) 109. The communication signal(s) 109 between the computing system 102 and unmanned vehicle 120 may be communicated at a particular communication frequency.

In some examples, computing system 102 may receive unmanned vehicle information 122 from an unmanned vehicle 120, the unmanned vehicle information 122 including video data comprising a plurality of video frames 123. An example of a plurality of video frames 123 is also shown in FIGS. 2A-2B. In some examples, computing system 102 may determine to add one or more additional video frames 126 to the plurality of the video frames 123. In some examples, computing system 102 may determine to add one or more additional video frames to the plurality of the video frames based on a determination of a degradation of a communication signal 109 for the unmanned vehicle 120 and/or a blackout of communication for the unmanned vehicle 120. In some examples, computing system 102 may determine to add one or more additional video frames to the plurality of the video frames based on a determination that the video data received from unmanned vehicle information 122 has one or more missing frames 126′ among the plurality of the video frames 123. In some examples, the “missing frames” may represent frames expected to be included in the received video data but are not present in the video data received from unmanned vehicle 120. This may be a result of a degradation of communication signal 109, a communication interruption, or a communication blackout between unmanned vehicle 120 and computing system 102. In some examples, computing system 102 may determine the video data has one or more missing frames among the plurality of video frames 123, such as the positions of frames 126 shown FIG. 2B. In some examples, the missing frames may extend for a period of time up to 5 seconds, up to 10 seconds, up to 30 seconds, or for longer duration of time, such as up to 5 minutes, 10 minutes, 15 minutes, 30 minutes, etc.

In some examples, during communication interruption, an unmanned vehicle 120 may not be able to receive operating instructions from operator 153 of operating system 102. There are instances when unmanned vehicle 120 losing contact with computing system 102 and operator 153 creates potential disruptions in mission execution. Previously, in such cases, unmanned vehicles have resorted to returning to their initial position or hovering, leading to a decrease in mission efficiency.

In accordance with techniques described herein, during times of communication interruption between unmanned vehicle 120 and computing system 102, instead of operating solely based on further operator instructions received via communication signal 109, unmanned vehicle 120 may continue to operate autonomously based at least on the instructions the unmanned vehicle 120 previously received with respect to item of interest 130 and the data unmanned vehicle 120 continues to gather with respect to item of interest 130. Unmanned vehicle 120 may continue to operate autonomously based additionally or alternatively on preset mission objectives, such as prioritizing items of interest with a higher priority than items of interest with a lower priority. Unmanned vehicle 120 may determine an engagement path of unmanned vehicle 120 based on respective priority values of a plurality of items of interest 130 and the positioning of the respective items of interest 130 with respect to unmanned vehicle 120.

In some examples, such as shown in FIG. 2A, computing system 102 may intersperse additional video frames 126 among a plurality of video frames 123 received from the unmanned vehicle 120 to generate a video stream. In some examples, such as shown in FIG. 2A, the generated additional video frames 126 may comprise frames to be interspersed between received frames 123 to generate a higher-quality video stream than the video data received from the unmanned vehicle 120 to help enable an operator to have a more detailed view of the unmanned vehicle 120 environment and/or a more detailed view of the item of interest 130. Generated additional video frames 126 comprise computer-generated video data, i.e., not captured by an image capture device. In some examples, computing system 102 may determine the video data has one or more missing frames among the plurality of the video frames and position an additional video frame of the additional video frames as a replacement frame for a corresponding missing frame of the one or more missing frames. In FIG. 2A, missing frame positions may correspond to the positions where additional frames 126 were interspersed between video frames 123 that were received in the unmanned vehicle information 122 from the unmanned vehicle 120.

In some examples, computing system 102 may determine a status of communication signal 109. Based on determining the communication signal 109 has degraded, computing system 102 may generate additional video frames 126 as described above. Communication signal 109 may be considered degraded when the radio frequency is less than a preferred rate, when communication signal 109 is unstable, when a signal-to-noise ratio for communication signal 109 has dropped below a threshold, a bit error rate is greater than a threshold, latency is greater than a threshold, there is loss of signal integrity, a high packet loss, security breaches or signal tampering, or other communication signal 109 degradation. In some examples, the communication interruption may be due to a variety of reasons, such as geography of the operation area of the unmanned vehicle 120, communication limitations of the unmanned vehicle 120, and/or deliberate communication jamming.

In some examples, such as shown in FIG. 2B, computing system 102 may position additional video frames 126 between video frames 123 received from the unmanned vehicle 120. For example, the generated additional video frames 126, such as shown in FIG. 2B, may represent seconds to minutes of video stream that may help enable an operator to have a projected view of the unmanned vehicle's environment and/or item of interest 130 when an operator's computing system is not receiving video data from the unmanned vehicle for a period of time (e.g., the period of time between receiving video frames 123).

Computing system 102 may process, with ML model 110, one or more of unmanned vehicle information 122 that includes video data comprising a plurality of frames 123, operator intent information 113, or environment information 114 to generate the one or more additional frames 126. In some examples, the environment information 114 may be based on the unmanned vehicle information 122 and may include at least one of item of interest 130 information, location information for item of interest 130, a trajectory or predicted trajectory for item of interest 130, location and/or trajectory information for other objects in the vicinity of item of interest 130, terrain information, location information for the unmanned vehicle 120, a trajectory or planned trajectory of unmanned vehicle 120 as determined by control module 107 in accordance with operator intent information 113. In some examples, computing system 102 may determine at least some of the environment information 114. In some examples, computing system 102 may receive at least some of the environment information 114 from unmanned vehicle 120.

In some examples, by processing, with ML model 110, the unmanned vehicle information 122 that includes video data comprising a plurality of frames 123 and environment information 114 for unmanned vehicle 120, computing system 102 may generate the one or more additional frames 126 to predict and/or interpolate video data for the missing frames in the video data received from unmanned vehicle 120. Computing system 102 may generate the one or more additional frames 126 to be replacement frames for the missing frames.

Computing system 102 may output a video stream comprising video frames 123 received from the unmanned vehicle 120 and one or more additional video frames 126 generated by computing system 102. In some examples, the output video stream that includes the one or more additional frames 126 may provide an improved informative video stream to an operator of unmanned vehicle 120 that may improve an operator's ability to make strategic planning decisions for the unmanned vehicle 120 even during a period of time of communication degradation and/or communication blackout between unmanned vehicle 120 and computing system 102.

In some examples, computing system 102 may output a video stream via one or more output devices 140 or to operator device 146 to display the video stream for an operator of unmanned vehicle 120 to view.

Some examples of system 100 include operator device 146 that is a separate device used by operator 153 to interact with computing system 102 and/or unmanned vehicle 120. Operator device 146 may represent a computer, a laptop, a tablet computing device, a mobile device (e.g., mobile phone), thin client, unmanned vehicle controller, or other device. Operator device 146 includes a display device, such as those described above with respect to output devices 140. In some examples, operator device 146 executes control module 107 or an agent thereof.

Operators may devise plans and make decisions for an unmanned vehicle, such as whether to engage an item of interest, when to engage the item of interest, where to engage the item of interest, and/or how to engage the item of interest. Operators may use a continuous flow of image data from an unmanned vehicle to make such important and timely decisions. However, during periods of time of communication degradation and/or communication blackout, the continuous flow of images (e.g., video data) may be interrupted which may make an operator less informed of an unmanned vehicle's situation which may make an ability for an operator to make an informed plan and/or decision for an unmanned vehicle more difficult. In accordance with the techniques of the computing system 102 described above, computing system 102 augmenting video stream with additional video frames during periods of communication degradation and/or communication blackout may help solve these issues and enable an operator to devise make an informed plan and/or decision for an unmanned vehicle 120, such as whether to engage an item of interest, when to engage the item of interest, where to engage the item of interest, and/or how to engage the item of interest, during communication degradation and/or communication blackout.

For example, operator 153 of computing system 102 may be operating unmanned vehicle 120 to engage an item of interest 130. During operation, unmanned vehicle 120 may generate unmanned vehicle information 122, which may include video data captured by camera device(s) 124 that show details about the item of interest 130, such as a pose of the item interest 130, movement of the item of interest 130, positioning of the item of interest 130 with respect to the terrain, particularities of the terrain surrounding the item of interest 130, etc. Unmanned vehicle 120 may transmit the unmanned vehicle information 122 to computing system 102 so operator 153 can make informed decisions on how to operate unmanned vehicle 120 with respect to the item of interest 130. Operator 153 inputs further operating instructions, relayed via computing system 102, to unmanned vehicle 120 regarding how to engage item of interest 130 based on unmanned vehicle information 122 received as operating instructions via communication signals 109.

For a variety of reasons, such as geography of the operation area of unmanned vehicle 120, range, communication limitations, and/or deliberate communication jamming, a communication signal 109 between unmanned vehicle 120 and computing system 102 may be interrupted, which may lead to missing video frames 126′ in video frames 123 received from the unmanned vehicle 120. In some examples, during the communication interruption between unmanned vehicle 120 and computing system 102, computing system 102 may determine missing video frames 126′ are due to a degradation of a communication signal 109 between unmanned vehicle 120 and computing system 120 and/or a due to blackout of communication between unmanned vehicle 120 and computing system 102.

During times of communication interruption between unmanned vehicle 120 and computing system 102, instead of operating based on continuously received operator instructions, unmanned vehicle 120 may operate autonomously for a time. However, while unmanned vehicle 120 continues to operate autonomously, the communication interruption may also lead to missing video frames 126′ in video frames 123 received from the unmanned vehicle 120, which may lead to operator 153 not being fully informed of the status of unmanned vehicle 120 with respect to item of interest 130, such as a position of unmanned vehicle 120 with respect to item of interest 130, movement of item of interest 130, activities of item of interest 130, etc.

Computing system 102 may generate replacement video frames 126 for the missing frames 126′ and output a video stream that includes video frames 123 received from unmanned vehicle 120 and replacement video frames 126. The generated video stream including replacement frames 126 may help inform operator 153 of computing system 102 of the status of unmanned vehicle 120 with respect to the item of interest 130 during times of communication interruption. Computing system 102 may generate replacement frames 126 by processing video frames 123 received from unmanned vehicle 120 and projected operator intent information with respect to item of interest 130. Computing system 102 may determine the projected operator intent information based on operator intent information 113 and at least one of a projected location of item of interest 130, a predicted trajectory for item of interest 130, a priority value of item of interest 130, or a classification of the item of interest 130. For example, when an item of interest 130 is a vehicle, a classification of an item of interest 130 may be classifying whether the item of interest 130 is a truck, car, or other type of vehicle. In some examples, computing system 102 may determine at least one of a projected location of item of interest 130 or a predicted trajectory for item of interest 130 based at least on received unmanned vehicle information 122.

In some examples, computing system 102 may determine projected operator intent information based on a projected engagement path of unmanned vehicle 120 that may be based on respective priority values of a plurality of items of interest 130 (e.g., operator intent information 113), the positioning of respective items of interest 130 with respect to unmanned vehicle 120, the projected positioning of respective items of interest 130 with respect to unmanned vehicle 120, and a determination of the most efficient engagement path (e.g., projected engagement path). Determining the projected operator intent information may help computing system 102 determine a projected positioning of unmanned vehicle 120 with respect to item of interest 130 and terrain surrounding item of interest 130, which may enable computing system 102 to generate more accurate additional video frames 126 to replace the missing frames 126′.

Computing system 102 then outputs a video stream comprising received video frames 123 and generated additional frames 126 that enables operator 153 to be better informed of the status of the unmanned vehicle during communication interruption which may enable operator 153 to send unmanned vehicle 120 more informed operating instructions quicker when communication between computing system 102 and unmanned vehicle 120 is restored.

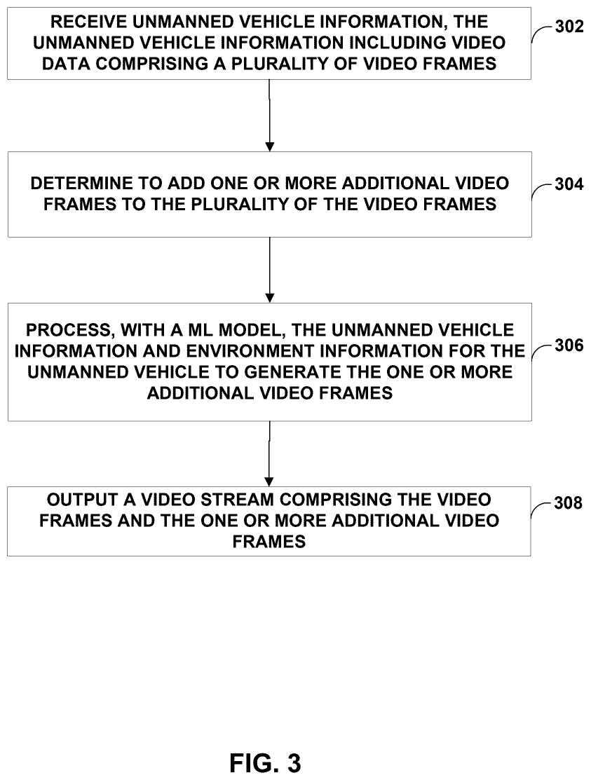

FIG. 3 is a flowchart illustrating an example operation in accordance with the techniques of the disclosure. FIG. 3 is described with respect to FIGS. 1, 2A, and 2B. However, in other examples, the operation of FIG. 3 may be performed by other systems that implement the techniques of the disclosure.

Computing system 102 may receive unmanned vehicle information 122 from an unmanned vehicle 120, the unmanned vehicle information 122 including video data comprising a plurality of video frames 123 (302). In some examples, the unmanned vehicle information 122 includes at least one of accelerometer data of the unmanned vehicle 120 or GPS data of the unmanned vehicle 120.

Computing system 102 may determine to add one or more additional video frames 126 to the plurality of the video frames 123 (304). In some examples, computing system 102 may determine a degradation of a communication signal 109 between unmanned vehicle 120 and receiver 108 and/or 112 for computing system 102. In some examples, computing system 102 may determine a degradation of the communication signal 109 has occurred based on determining a video channel of the communication signal 109 has dropped, determining an expected video frame is not received, and/or determining a reduction of communication frequency of the communication signal 109.

In some examples, computing system 102 may determine to add one or more additional video frames 126 to the plurality of the video frames 123 based on a determination of a degradation of a communication signal 109 and/or a blackout of communication between unmanned vehicle 120 and computing system 102. In some examples, computing system 102 may determine the video data has one or more missing frames among the plurality of the video frames 123. In some examples, computing system 102 may determine to add one or more additional video frames 126 to the plurality of the video frames 123 based on a determination that the video data received from unmanned vehicle information 122 has one or more missing frames among the plurality of the video frames 123. In some examples, the “missing frames” may represent frames expected to be included in the received video data but are not present in the video data received from unmanned vehicle 120, such as being due to a degradation of communication signal 109. In some examples, the “missing frames” may represent frames expected to be included in the received video data but are not present in the video data received from unmanned vehicle 120, such as being due to a communication interruption or communication blackout between unmanned vehicle 120 and computing system 102.

Computing system 102 processes, with ML model 110, the unmanned vehicle information 122, and environment information 114 to generate the one or more additional frames 126 (306). In some examples, computing system 102 may be configured to determine at least some of environment information 114 based on unmanned vehicle information 122 and at least one of item of interest 130 information, the location information for unmanned vehicle 120, the trajectory of unmanned vehicle 120, or the planned trajectory of unmanned vehicle 120 as determined by control module 107 in accordance with operator intent information 113. In some examples, computing system 102 may receive at least some of environment information 114 from unmanned vehicle 120.

In some examples, item of interest 130 information may include at least one of a projected location of item of interest 130, a trajectory for item of interest 130, a predicted trajectory for item of interest 130, a priority value of item of interest 130, or a classification of the item of interest 130. Item of interest 130 can be any object, such as a vehicle (including an unmanned vehicle), person, building, natural feature, or animal. In some examples, item of interest 130 is a target. For example, item of interest 130 information may include a current position of item of interest 130, a projected position of item of interest 130 and the predicted trajectory on how the item of interest 130 moves from its current position to the projected position.

In some examples, models 110 includes one or more models to predict one or more of a future location or a trajectory for one or more of unmanned vehicle 120 or item of interest 130. For example, models 110 may include SLAM (Simultaneous Localization and Mapping) model to estimate the trajectory of item of interest 130 while simultaneously building a map of its environment. The SLAM model may include a localization component to estimating a position and orientation (pose) of item of interest 130 over time, a mapping component to build a representation of the surrounding environment, and a trajectory estimation component to derive a continuous or discrete path that item of interest 130 follows. The SLAM model may be filter-based (e.g., Kalman filter or particle filter), graph-based, direct, optimization-based, visual and thereby leveraging camera data for trajectory and mapping, lidar, or hybrid.

Computing system 102 may process, with one or more models 110, video frames 123 to predict one or more of the future location or the trajectory for one or more of unmanned vehicle 120 or item of interest 130. Environment information 114 may include the predicted future location or trajectory for unmanned vehicle 120, mapping information generated by the SLAM model, or other information predicted by models 110 useful for generating additional video frames as described herein. Item of interest information for item of interest 130 may include the predicted future location or predicted trajectory for item of interest 130.

In some examples, based on the determination of the degradation of the communication signal 109, computing system 102 may process, with the ML model 110, unmanned vehicle information 122 and environment information 114 for the unmanned vehicle 120 to generate the additional video frames 126.

In some examples, computing system 102 may intersperse the additional video frames among the plurality of video frames to generate the video stream. In some examples, computing system 102 may position an additional video frame of the additional video frames as a replacement frame for a respective missing frame of the one or more missing frames.

In some examples, computing system 102 may output a video stream comprising video frames 123 received from the unmanned vehicle 120 and the one or more additional video frames 126 generated by computing system 102 (308). In some examples, the output video stream that includes the one or more additional frames 126 may provide an improved informative video stream to operator 153 of unmanned vehicle 120 that may improve an ability of operator 153 to make strategic planning decisions for unmanned vehicle 120 even during a period of time of communication degradation and/or communication blackout between unmanned vehicle 120 and computing system 102.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system to generate one or more additional frames to add to data received from an unmanned vehicle to generate a data stream, the computing system comprising:
processing circuitry; and
memory configured to store a machine learning model, wherein the processing circuitry is configured to:
receive unmanned vehicle information from the unmanned vehicle, the unmanned vehicle information including the data comprising a plurality of frames;
determine to add the one or more additional frames to the plurality of the frames;
process, with the machine learning model, the unmanned vehicle information and environment information for the unmanned vehicle to generate the one or more additional frames, the environment information being based on the unmanned vehicle information and including at least one of item of interest information, terrain information, location information for the unmanned vehicle, a trajectory of the unmanned vehicle, or a planned trajectory of the unmanned vehicle; and
output the data stream comprising the frames and the one or more additional frames.

2. The computing system of claim 1, wherein the data includes video data, the frames are video frames, the additional frames are additional video frames, and the data stream is a video stream comprising the video frames and the one or more additional video frames.

3. The computing system of claim 1, wherein the data includes audio data, the frames are audio frames, the additional frames are additional audio frames, and the data stream is an audio stream comprising the audio frames and the one or more additional audio frames.

4. The computing system of claim 1, wherein the computing system is further configured to determine at least some of the environment information based on the unmanned vehicle information.

5. The computing system of claim 1, wherein the computing system is configured to receive at least some of the environment information from the unmanned vehicle.

6. The computing system of claim 1, wherein the unmanned vehicle information comprises at least one of accelerometer data of the unmanned vehicle, global positioning system (GPS) data of the unmanned vehicle, altimeter data of the unmanned vehicle, or compass data of the unmanned vehicle.

7. The computing system of claim 1, wherein the computing system is further configured to:
determine a degradation of a communication signal between the unmanned vehicle and a receiver for the computing system; and
based on the determination of the degradation of the communication signal between the unmanned vehicle and the receiver for the computing system, process, with the machine learning model, the unmanned vehicle information and the environment information for the unmanned vehicle to generate the additional frames.

8. The computing system of claim 7, wherein to determine the degradation of the communication signal, the computing system is configured to one or more of:
determine a channel of the communication signal has dropped,
determine an expected frame is not received, or
determine a reduction of communication frequency of the communication signal.

9. The computing system of claim 1, wherein the item of interest information includes at least one of a projected location of the item of interest, a trajectory for the item of interest, a predicted trajectory for the item of interest, a priority value of the item of interest, or a classification of the item of interest.

10. The computing system of claim 1, wherein the computing system is further configured to determine projected operator intent information based on operator intent information and at least one of a projected location of the item of interest, a predicted trajectory for the item of interest or a priority value of the item of interest; and
process, with the machine learning model, the unmanned vehicle information and the projected operator intent information to generate the one or more additional frames.

11. The computing system of claim 1, wherein the computing system is further configured to:
intersperse the additional frames among the plurality of frames to generate the data stream.

12. The computing system of claim 1, wherein the computing system is further configured to:
determine the data has one or more missing frames among the plurality of the frames; and
position an additional frame of the additional frames as a replacement frame for a respective missing frame of the one or more missing frames.

13. A method for generating one or more additional video frames to add to video data received from an unmanned vehicle to generate a video stream, the method comprising:
receiving unmanned vehicle information from the unmanned vehicle, the unmanned vehicle information including the video data comprising a plurality of video frames;
determining to add the one or more additional video data frames to the plurality of the video frames;
processing, with a machine learning model, the unmanned vehicle information and environment information for the unmanned vehicle to generate the one or more additional video frames, the environment information being based on the unmanned vehicle information and including at least one of item of interest information, terrain information, location information for the unmanned vehicle, a trajectory of the unmanned vehicle, or a planned trajectory of the unmanned vehicle; and
outputting the video stream comprising the video frames and the one or more additional video frames.

14. The method of claim 13, further comprising:
determining at least some of the environment information based on the unmanned vehicle information.

15. The method of claim 13, wherein the unmanned vehicle information further comprises at least one of accelerometer data of the unmanned vehicle, global positioning system (GPS) data of the unmanned vehicle, altimeter data of the unmanned vehicle, or compass data of the unmanned vehicle.

16. The method of claim 13, further comprising:
determining a degradation of a communication signal between the unmanned vehicle and a receiver for a computing system; and
based on the determination of the degradation of the communication signal between the unmanned vehicle and the receiver for computing system, processing, with the machine learning model, the unmanned vehicle information and the environment information for the unmanned vehicle to generate the additional video frames.

17. The method of claim 13, wherein the item of interest information includes at least one of a projected location of the item of interest, a trajectory for the item of interest, a predicted trajectory for the item of interest, a priority value of the item of interest, or a classification of the item of interest.

18. The method of claim 13, further comprising:
interspersing the additional video frames among the plurality of video frames to generate the video stream.

19. The method of claim 13 further comprising:
determining the video data has one or more missing frames among the plurality of the video frames; and
positioning an additional video frame of the additional video frames as a replacement frame for a respective missing frame of the one or more missing frames.

20. A non-transitory computer-readable medium comprising machine readable instructions to cause processing circuitry to:
receive unmanned vehicle information from an unmanned vehicle, the unmanned vehicle information including video data comprising a plurality of video frames;
determine to add one or more additional video data frames to the plurality of the video frames;
process, with a machine learning model, the unmanned vehicle information and environment information for the unmanned vehicle to generate the one or more additional video frames, the environment information being based on the unmanned vehicle information and including at least one of item of interest information, terrain information, location information for the unmanned vehicle, a trajectory of the unmanned vehicle, or a planned trajectory of the unmanned vehicle; and
output a video stream comprising the video frames and the one or more additional video frames.
